(19) United States
(12) Patent Application Publication
(10) Pub. No.: US 2025/0349224 A1
(43) Pub. Date: Nov. 13, 2025

(54) A SYSTEM FOR DISPLAYING INTERACTIVE TRAINING SCENARIO AND FOR DETERMINING THE POSITION OF RELEVANT OBJECTS IN A TRAINING RANGE AND A METHOD OF SYSTEM SET UP AND CALIBRATION

(71) Applicant: GUARDIARIS D.O.O., Ljubljana (SI)

(72) Inventors: Stas Hvala, Ljubljana (SI); Bogdan Golobic, Ljubljana (SI); Srecko Knezevic, Ljubljana (SI); Luka Zupancic, Ljubljana (SI); Primoz Peterca, Ljubljana (SI)

(21) Appl. No.: 18/871,143

(22) PCT Filed: Jun. 1, 2022
(86) PCT No.: PCT/SI2022/050017

§ 371 Date: Dec. 2, 2024

(51) Int. Cl. G09B 9/00; G06T 7/70; G06T 7/80

(52) U.S. Cl. CPC G09B 9/003; G06T 7/70; G06T 7/80; G06T 2207/30204; G06T 2207/30244

(57) ABSTRACT

The invention relates to a system for training, where a training scenario is displayed on a screen and trainees interact with the training scenario, for example point a training weapon replica and fire at a virtual target displayed within the training scenario, so the system needs to determine in real time the position and/or orientation of a trainee or other object relevant for training, such as a training weapon replica, in order to determine, for example, whether the trainee hits a target with the weapon replica. More particularly, the invention relates to a training system for displaying an interactive training scenario and to a method of its calibration, wherein the proposed system enables portability and setting up a training environment easily and quickly for example wherever we can find a large white surface for a main screen and source of electricity to power the training system.

The invention relates to systems for training, including various types of combat training, where a training scenario is displayed on a screen and trainees interact with the training scenario, for example point a training weapon replica and fire at a virtual target displayed within the training scenario, so the system needs to determine in real time the position and/or orientation, often also referred to as three or up to six degrees of freedom, of a trainee or other object relevant for training, such as a training weapon replica, in order to determine, for example, whether the trainee hits a target with the weapon replica. More particularly, the invention relates to a portable and easily transportable, mobile training system that enables setting up the training environment in more diverse situations, and to calibration method for setting up the training system more easily and quickly.

The invention builds upon known training systems in which the position and/or orientation of an object, such as a trainee or a weapon replica, within a working area of a training range is determined by analyzing images captured by a positional camera attached to the object. Namely, during the training, the positional camera captures images of positional fields or patterns of a particular shape which are emitting EM waves of a certain wavelength. Positional patterns are statically positioned relative to a main screen, where a training scenario is projected to by a projector, in such a way that during the training the positional camera captures at least one positional pattern, preferably more, so as to enable the determination of the position and orientation of the object relative to the main screen and relative to the interactive training scenario displayed on the main screen. Information on the position and/or orientation of the object comprises some or all data points describing the body in a three-dimensional space, for example in systems with six degrees of freedom three data points represent the position (X, Y, Z) and three data points describe the orientation, namely yaw, pitch and roll; in systems with three degrees of freedom three data points describe the orientation, namely yaw, pitch and roll. The calculation necessary for determining the position and orientation of the object from the images of positional patterns captured by the positional cameras is done by a computer with an appropriate software module. The position and orientation of the object with possible additional inputs, such as from the triggering device on a training weapon replica, is integrated with the displayed training scenario with appropriate software modules, so that the interactive nature of the trainee's activities and the displayed training scenario is achieved. Such systems are disclosed for example in WO 2018/088968. One of the main drawbacks of these systems is that they are not portable and easily transportable between training locations and that setting up such training systems is time consuming and costly.

The main purpose of this invention is to overcome these drawbacks by designing a training system for displaying an interactive training scenario and method of its calibration that allows portability and setting up a training environment easily and quickly for example wherever we can find a large white surface for a main screen and source of electricity to power the training system.

Once the training system for displaying the interactive training scenario and determining the position of relevant objects is set up, it comprises elements from a portable system, such as a pattern projecting device, a computer, positional camera(s), and other elements, such as a main screen, which can be for example a sufficiently large wall, onto which the interactive training scenario can be projected, and around which the training system can be set up. It is clear to the person skilled in the art that in some embodiments also the main screen can be a part of the portable system, as various portable inactive screens in combination with projectors are known in the state of the art.

Within the context of this description, the term ‘working area’ refers to a limited spatial area within a training range, within which a trainee or a relevant object is intended to move during the training.

The training system is further described in detail below and presented in figures, where:

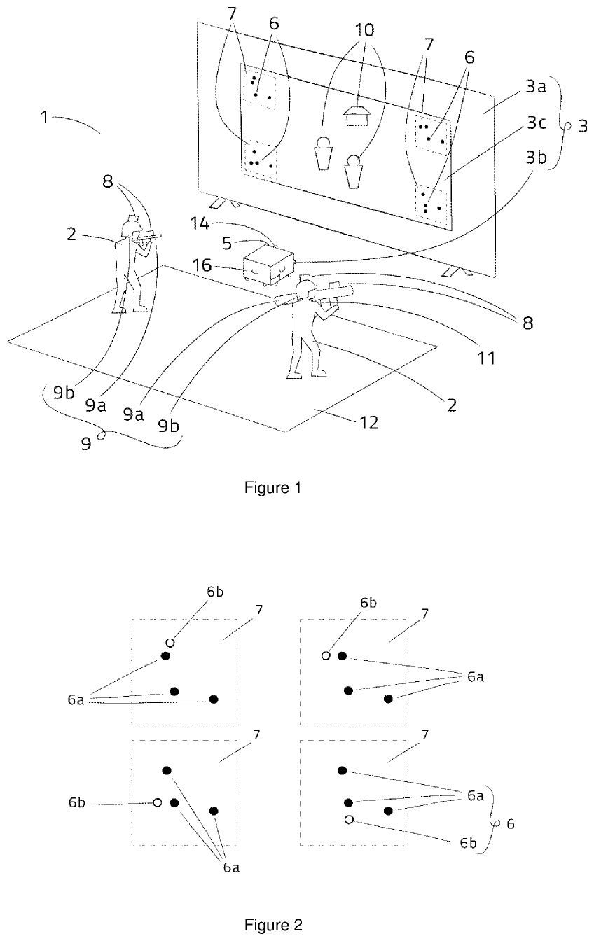

FIG. 1 shows the training system 1 with trainees 2 during the training

FIG. 2 shows four positional patterns 6 as projected by a pattern projecting device 5 onto positional reflective screens 7

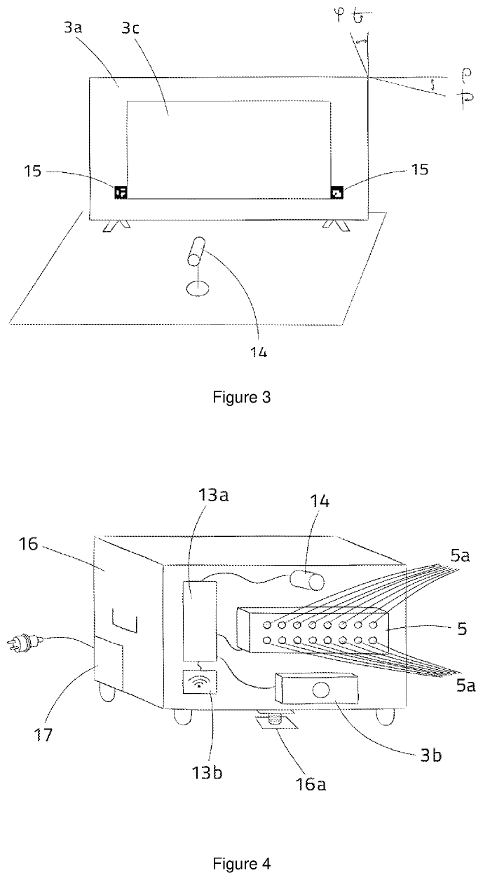

FIG. 3 shows a main screen 3 with an effective screen 3c and two fiducial markers 15

FIG. 4 shows a portable case 16 for various devices of the training system 1

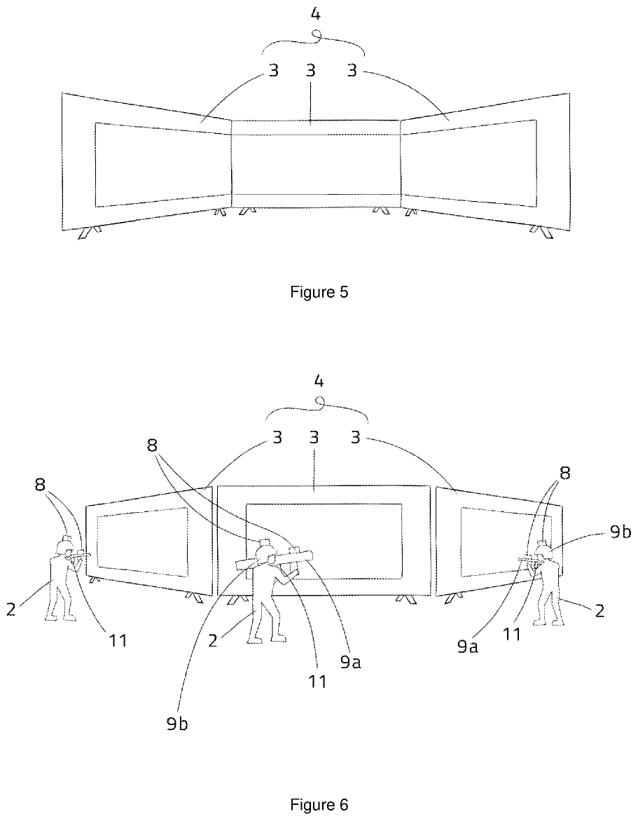

FIG. 5 shows a combined screen 4 comprising three main screens 3 and positioned in concave shape

FIG. 6 shows the combined screen 4 comprising three main screens 3 and positioned in convex shape

The training system 1 comprises the following:
the main screen 3 configured for displaying the interactive training scenario within the band of electromagnetic (EM) wavelengths of visual light, i.e., within band V;
at least two positional reflective screens 7, onto which the positional patterns 6 are projected;
-a pattern projecting device 5 configured for projecting the positional patterns 6 onto the positional reflective screens 7 in the near infrared (NIR) spectrum, i.e., within the band of the EM wavelengths between 780 nm to 2500 nm, hereinafter referred to as band R, preferably between 800 nm to 1600 nm;
at least one positional camera 8 configured for capturing images in the band R, which is attached to the relevant object 9, i.e. relevant to the training and the interactive training scenario, and of which the position and orientation is to be determined for enabling the interaction with the interactive training scenario, for example a training weapon replica or the trainee or both;
a computer 13 with processing and memory capabilities and connection means for connecting at least with the main screen and the positional camera(s) 8, configured for running a positioning software module which determines in real time the position and/or orientation of the relevant objects 9, and for running the scenario software module which operates the displaying of the interactive training scenario on the main screen 3, integrates the interactive training scenario on one hand, and position(s) and orientation(s) of the relevant object(s) 9 on the other, and optionally also additional inputs from additional input devices 11, preferably a triggering device, on the relevant object 9, and consequently enables the interaction of the trainee with the interactive training scenario.

In embodiments, which enable a calibration method, the training system further comprises:
a calibration camera 14 configured for capturing images both in the band V and the band R, connected to the computer 13,
a calibration software module which runs on the computer 13 and is configured for operating a calibration process.

The main screen 3, where the interactive training scenario is displayed, can be implemented in several known ways. Within the context of this invention in one possible embodiment, the main screen 3 comprises an inactive screen 3a, such as a white flat wall or a projection screen, and a projector 3b which projects the interactive training scenario onto the inactive screen 3a and is connected to the computer 13. In another embodiment, the main screen 3 can also be implemented as an active screen, such as one or combination of many TV or gaming computer monitors of various technologies, for example plasma, LED, OLED, QLED. As the purpose of the main screen 3 is for the trainee to see the interactive training scenario and react thereto, the main screen displays the interactive training scenario in visual light, i.e. in band V. The area on the main screen 3, which is delimited by the borders of the interactive training scenario as displayed on the main screen 3, is defined as the effective screen 3c. Depending on particular embodiments, the effective screen 3c can be implemented as a flat surface (linear), curved surface, such as circular, ellipsoid or of other polynomial curvatures, or combination of flat surfaces (piece wise linear) and/or curved surfaces.

Each positional pattern 6 is projected by the pattern projecting device 5 onto the corresponding positional reflective screen 7 which is fixedly positioned relative to the main screen 3. The positional reflective screens 7 have an appropriate surface so as to reflect the EM waves within band R in a wide angle. This enables the positional camera(s) 8 to capture the image of the positional pattern(s) 6 projected to the positional reflective screen(s) 7 from almost all angles. Furthermore, the shape of the surface of each positional reflective screen 7 should preferably be flat and smooth or at least of known and repeatable geometry, so that the image of the projected positional pattern 6 is not distorted. Such distortions could cause or contribute to errors in calculation of the position and orientation of the relevant object 9, namely, the algorithm of the positioning software module may misinterpret the distorted image of the positional pattern 6 for a different position and/or orientation of the positional camera 8 in relation to the particular positional pattern 6.

The positional reflective screens 7 can be integrated with the main screen 3, if the latter is implemented as inactive screen 3a, and if the parts of the main screen 3, which will be used as positional reflective screens 7, respectively, satisfy conditions therefor.

Given that the interactive training scenario is displayed in band V and the positional patterns 6 are projected in band R, whereas band V is relatively far apart from band R, it is possible in some embodiments that the positional reflective screens 7 are positioned even within the effective screen 3c of the main screen 3, because the positional camera 8 capturing the image of positional patterns 6 in band R should not be significantly disturbed by the interactive training scenario displayed in band V. In cases where the main screen 3 is implemented as an inactive screen 3a with the projector 3b and the positional reflective screens 7 are integrated with the main screen 3, the positional patterns 6 can be projected onto the main screen 3 within the effective screen 3a. In cases, where the main screen 3 is implemented as an active screen, so the positional reflective screens 7 cannot be integrated with the main screen 3, the positional reflective screens 7 can be placed right in front of the main screen 3, preferably essentially in the same plane as the main screen 3, and possibly within the borders of the effective screen 3c.

In other embodiments the positional reflective screens 7 can be positioned outside the borders of the effective screen 3c, but preferably near the borders. The positional reflective screens 7 can also be integrated with each other, for example as one or two connected surfaces or a surface in the shape of a band around the effective screen 3c or main screen 3. In most preferred embodiments, the positional reflective screens 7 are placed in or near the corners of the effective screen 3c.

The pattern projecting device 5 is fixedly positioned and projects the positional patterns 6 to corresponding positional reflective screens 7 in band R with sufficient precision and focus, because the sharpness of the positional patterns 6 projected to the positional reflective screens 7 significantly influences the precision of calculation of the position and/or orientation of the positional camera 8/relevant object 9. The pattern projecting device 5 can be implemented in various known ways, for example as a set of laser sources of EM waves of band R or (near) infrared light emitting diodes with corresponding collimating optics, and various known optics technologies for directing, shaping and/or focusing the positional patterns 6 as projected to the positional reflective screens 7, such as diffraction grating or digital light processing in optional combination with optical masks.

In some embodiments, the pattern projecting device 5 projects the positional patterns 6 in iterative time intervals in order to save power, prevent overheating and to extend the lifetime of the pattern projecting device 5; in this case, the frequency of the intervals should be sufficiently higher than frequency of image capturing by the positional camera 8.

Algorithms, within the positioning software module which runs on the computer 13, for computing the position and/or orientation of the relevant object 9 from the images (2D) of the positional patterns 6 on the positional reflective screens 7, captured by the positional camera 8 fixedly attached to the relevant object 9, are known, for example visual simultaneous localization and mapping (SLAM) algorithms, marker SLAM algorithms, extended Kalman filter algorithms or Perspective-3-Point (P3P) algorithms. The positional camera 8 should simultaneously capture at least two positional patterns 6 for enabling the algorithm to calculate the position and/or the orientation of the positional camera 8/relevant object 9 reliably and precisely.

The positional patterns 6 are projected to the positional reflective screen 7 in a predefined position relative to the effective screen 3c. Preferably, the positional patterns 6, as projected onto the positional reflective screens 7, are composed of a set of dots, because it is relatively easy to design a pattern projecting device 5 for projecting dots. The positional patterns 6 could also be composed of other predetermined geometrical shapes, e.g., lines, squares, or various combinations thereof, which are then used to calculate the position and/or orientation of the relevant object 9.

Each positional pattern 6 comprises at least two sub-patterns, namely a localization sub-pattern 6a which enables the algorithm to determine the position and orientation of the positional camera 8 relative to the positional pattern 6 (or vice versa), and an identification sub-pattern 6b which makes by itself or in combination with the localization sub-pattern 6a each positional pattern 6 unique, so that the algorithm can recognize also which positional patterns 6 are captured in each image by the positional camera 8, which is also used for calculating the overall position and/or the orientation of the positional camera 8/relevant object 9.

Given that the positional camera 8 should capture at least two positional patterns 6 for the system 1 to function properly, a sufficient number of positional reflective screens 7, on which positional patterns 6 are projected to, should be spatially distributed within or/and around the main screen 3, preferably essentially on the same plane as lies the main screen 3. The exact distribution of the positional patterns 6 depends predominantly on the size of the main screen 3, the positional camera's field of view, namely the angle of image capturing, which is typically 60° to 140°, preferably at least 90°, and the proximity of the working area 12, in which the relevant objects 9 with the positional cameras 8 move, to the main screen 3 or to the positional reflective screens 7. Preferably, the angle between two lines from centers of two neighboring positional patterns 6 to the positional camera 8 should not exceed 37° in order for the positional camera 8 to capture constantly and reliably at least two neighboring positional patterns 6.

For example, in FIG. 1 an embodiment of the training system 1 is shown in which four positional patterns 6 are distributed around the inactive screen 3a, which is a part of the main screen 3, namely one positional pattern 6 in each corner of the effective screen 3c. The localization sub-pattern 6a in this embodiment comprises three dots, shown schematically as black dots in FIG. 2, and is identical in all four positional patterns 6 shown in FIGS. 1 and 2. The identification sub-pattern 6b in this embodiment comprises one dot, shown schematically as a white dot in FIG. 2, which is in each positional pattern 6 in a different position relative to the localization sub-pattern 6a, thereby making each positional pattern 6 unique. Black and white dots are used in FIG. 2 merely for illustrative purpose; in reality all dots in the positional patterns as projected onto the reflective screens in this embodiment have essentially the same shape and intensity.

Each relevant object 9 within the working area 12 should have its own positional camera 8 attached thereto, because the positioning software module actually calculates the position and/or orientation of each positional camera 8, and this position and/or orientation is attributed to the corresponding relevant object 9. The position and/or orientation for each relevant object 9 is necessary for the relevant objects 9 to interact with the interactive training scenario. Depending on the interactive training scenario the examples of the relevant objects 9 are as follows: one or several weapon replicas 9a which will be used by the trainees 2 during the training, or even one or more trainees themselves in cases where the positions and/or orientations of the trainees are relevant to a particular training. If the position and/or the orientation of the trainees is relevant, the positional camera 8 can be attached for example on the trainees' helmets 9a. The frequency of capturing images by the positional cameras 8 should be sufficiently high in order to enable sufficient frequency of the calculated positions and/or orientations of the relevant objects 9 which are necessary for smooth interaction of the trainees 2 (relevant objects 9) with the interactive training scenario. Typically, the frequency of capturing images is 30 frames per second (30 Hz), and is the same or higher than the frequency of providing positioning data, for example 15 Hz.

The training system 1, in some embodiments, may comprise additional positioning devices (not shown in Figures), such as gyroscopes or accelerometers, attached to the relevant objects 9/positional cameras 8, wherein outputs from these devices are used by the positioning software module for calculating the position and/or orientation of the positional cameras 8. For example, by applying these known methods such as sensor fusion, the position and/or orientation of the positional cameras 8 can be calculated more precisely or with the frequency that is higher than the frequency of image capturing by the positional cameras 8. In these embodiments the frequency of capturing images by the positional cameras 8 is not necessarily the same or higher than the frequency of providing positioning data by the positioning software module.

The computer 13 on which the positioning software module, the scenario software module and the calibration software module are run may be implemented in various ways, for example as a laptop, possibly with one central processing unit, or composed of several components with separate processing units, for example graphic cards. The computer may also comprise several connected computers, for example a central computer 13a, and positional camera computers, each of which is embedded with each positional camera 8.

The positional camera 8 is connected to the computer 1 via cable or preferably wirelessly for transmitting captured images to the positioning software module or information on calculated positions and/or orientations to the scenario software module. The main screen 3 is also connected to the computer 13 via cable or wirelessly for enabling the scenario software module to operate displaying of the interactive training scenario on the main screen. In embodiments where the main screen 3 is implemented as an inactive screen 3a and the projector 3b, the projector 3b is connected to the computer 13.

The input data for the positioning software module are 2D images of the positional patterns 6 as captured by the positional camera(s) 8 and the output is the position and/or orientation in a predefined format for each of the relevant objects 9 to which each positional camera 8 is fixedly attached. The positions and/or orientations of the relevant objects 9 are expressed according to an internal positional coordinate system of the positioning software module which is defined by the positions of the positional patterns 6 as projected on the positional reflective screens 7.

The scenario software module is configured for operating the displaying of the interactive training scenario on the main screen 3 and the interaction of the trainee 2 (the relevant objects 9) with the interactive training scenario. The scenario software module has its own internal scenario coordinate system according to which the positions and/or orientation of the relevant virtual objects 10 shown in the interactive training scenario on the main screen 3 are expressed. The scenario software module is configured for receiving input data, namely the information on the positions and/or orientation of the (real) relevant objects 9 within the working area 12, and also possibly additional inputs such as from the triggering device 11.

In embodiments where the computer 13 comprises the central computer 13a and the positional camera computers, the positioning software module runs on each positional camera computer and calculates the position and/or orientation of the corresponding positional camera 8/relevant object 9 and sends the output to the scenario software module which runs on the central computer 13a.

In embodiments of the system which enable the calibration method, the system comprises also the calibration camera 14 and the calibration software module that runs on the computer 13.

The calibration camera 14 is capable of capturing images in band R and in band V. Namely, for the calibration purposes the calibration camera 14 should capture the positional patterns 6 as projected on to the positional reflective screens 7 in band R and the borders of the effective screen 3c which is displayed on the main screen 3 in band V. The calibration camera 14 may be implemented as a combination of two cameras, one for capturing images in band R and another in band V. During the calibration process, the calibration camera 14 is positioned in a preset position relative to the effective screen 3c and to the positional reflective screens 7, at a sufficient distance from them, that given its angle of capturing images the calibration camera 14 is capable of capturing the effective screen 3c and at least two positional patterns 6, preferably all positional patterns 6. The preset position should either be predefined or established during the calibration procedure, so that the preset position is known when the calibration software module calibrates the training system 1 as described below. In a preferred embodiment, the calibration camera 14 is fixedly attached to the pattern projecting device 5, so close that for calculation purposes they both have essentially the same preset position relative to the effective screen 3c (or to the positional reflective screens 7). It is also possible that the calibration camera 14 is fixedly attached to the pattern projecting device 5 at a known distance, which is taken into consideration in the calibration and computation process. Preferably, the preset position of the calibration camera 14 is such that it is placed horizontally symmetrically relative to the right hand side and left hand side borders of the effective screen, at predefined distances from each corner of the effective screen, and that the direction of the calibration camera 8 is perpendicular to the surface of the effective screen 3c.

The preset position of the calibration camera 14 can be measured or achieved in various known ways, for example manually by measuring the distances between the calibration camera 14 and the effective screen 3c or its borders, for example by a laser distance meter, and by measuring the angles of the direction of the calibration camera 14 relative to the effective screen 3c. In one of possible embodiments, the preset position can also be achieved in known ways by using fiducial markers 15, for example ArUco markers, with fiducial software module that runs on the computer. The fiducial markers 15 are attached to the same plane as the effective screen 3c within or outside the borders of the effective screen 3c. Preferably, two fiducial markers 15 are used and placed in or near the corners of the effective screen 3c. It is practical that the fiducial markers 15 are easily removable, for example they can be implemented as an image printed on a self-adhesive removable plate so that they can be removed after the calibration process is over; this is especially desirable, when the fiducial markers 15 are placed within the borders of the effective screen 3c, so that the fiducial markers 15 do not hinder the view of the interactive training scenario displayed on the main screen 3 during the training.

The calibration camera 14 captures the image of the fiducial markers 15 once they are placed on the main screen 3 and from 2D captured images the fiducial software module calculates the exact position (distances and/or angles) of the calibration camera 14 relative to fiducial markers, i.e. relative to the effective screen 3c. By moving the calibration camera 14, and/or possibly the main screen, and observing the output of the fiducial software module, the exact preset position necessary for the calibration process, and subsequently for functioning of the training system, can be achieved. Once the preset position is achieved, the main screen 3 and/or the calibration camera 14 is fixed.

In some embodiments the scenario software module may support several main screens 3, so that the interactive training scenario is displayed on a combined screen 4 comprising several main screens 3, for example three main screens 3 as shown in embodiments in FIG. 5 and FIG. 6. By doing that the trainees 2 are more surrounded with and therefore more immersed into the interactive training scenario, for example when the combined screen 4 is concave shaped, as shown in FIG. 5. In another embodiment, for example, when the combined screen 4 is convex shaped, a single scenario may be projected and seen from multiple angles, which enable multiple trainees 2 to interact with the same scenario, each from his/her own angle, as shown in FIG. 6.

The set up method of the training system 1 according to the present invention comprises the following steps:
Step 1: Setting up the main screen 3. The main screen 3 or its part, the inactive screen 3a, is either already at the site where the training system is being set up, for example a sufficiently large wall, or it needs to be set up, for example by positioning the inactive screen and the projector, or by positioning the active screen.
Step 2: Setting up the positional reflective screens 7. The positional reflective screens 7 are distributed around or within the borders of the effective screen 3c of the main screen 3, all facing essentially the same direction. If the positional reflective screens 7 are integrated with the main screen 3, this step is already accomplished with accomplishing step 1.
Step 3: Positioning the calibration camera 14. The calibration camera 14 is placed in the preset position, namely at known distances and angles relative to the effective screen 3c.
Step 4: Positioning the pattern projecting device 5 and projecting the positional patterns 6 onto the positional reflective screens 7. The pattern projecting device 5 is placed in a predefined position relative to the effective screen 3c (the main screen 3) and the positional reflective screens 7, preferably through the preset position of the calibration camera 14, more preferably the pattern projecting device 5 is placed in the essentially same position as the calibration camera 14, and the positional patterns 6 are projected to the positional reflective screens 7.
Step 5: Displaying an initial image on the main screen 3. On the main screen 3 the initial image is displayed which serves to delimit the borders of the effective screen 3c, and preferably consists of a blank (white) image covering the entire surface of the effective screen 3c. Other initial images are possible, but their borders must be sufficiently contrasting.
Step 6: Capturing the image of the positional patterns in band R and the initial image in band V. The calibration camera captures the image of the positional patterns in band R and the initial image in band V, delimiting the borders of the effective screen 3c.
Step 7: Computationally calibrating the internal positional coordinate system with the internal scenario coordinate system. Based on the image of the positional patterns in band R and the initial image in band V, as captured by the calibration camera 14, known position of the calibration camera 14, i.e. the preset position, known position of the pattern projecting device 5, and known positions of the positional patterns 6 as projected onto the positional reflective screens 5, the calibration software module calibrates the training system 1, more particularly, computationally aligns the internal positional coordinate system with the internal scenario coordinate system, so that the positions and/or orientations in a predefined format for each of the relevant objects 9 as an output of the positioning software module is applicable as input data for the scenario software module.

In some embodiments, step 3 above, namely positioning the calibration camera 14 in the preset position and consequently positioning the pattern projecting device 5, is achieved by applying the fiducial markers 15 and the fiducial software module, namely:
a) Placing at least one fiducial marker 15, preferably two fiducial markers 15 positioned in two corners of the effective screen 3c, in the same plane as the effective screen 3c within or outside the borders of the effective screen 3c. In another embodiment, one fiducial marker 15 is placed in or near each corner of the effective screen 3c.
b) Capturing the 2D image of the fiducial markers 15 by the calibration camera 14, and calculating by the fiducial software module the exact position (distances and angles) of the calibration camera 14 relative to the fiducial markers 15, i.e. relative to the effective screen 3c, from the 2D captured image.
c) Moving the calibration camera 14 (and/or possibly the main screen 3) and observing the output of the fiducial software module, until the exact preset position necessary for the calibration process is achieved.
d) Optionally, removing the fiducial markers 15 from the main screen 3.

In embodiments where the combined screen 4 comprises several main screens 3, the set up method and the calibration method should be done for each main screen 3.

A possible embodiment of the training system and parts thereof, which constitute the portable system for setting up the training system 1, are shown in FIGS. 1 through 4.

The main screen 3 is implemented as an inactive screen 3a and a projector 3b, whereas the projector 3b is connected to the central computer 3a by cable.

The pattern projecting device 5 is implemented as four sets of lasers 5a, wherein each set is configured for projecting one positional pattern 6 onto the corresponding positional reflective screens 7. Each set comprises four lasers 5a for projecting four laser dots which constitute a positional pattern 6 as shown in FIG. 2. The lasers 5a within the pattern projecting device 5 in this embodiment are fixedly attached to one another, so when the pattern projecting device 5 is placed in a predefined position relative to the positional reflective screens 7, all four positional patterns are projected to the positional reflective screens 7. The pattern projecting device 5 is connected to the central computer 13a by cable.

The positional reflective screens 7 are integrated with the main screen 3 in a way that four sections of the surface of the inactive screen 3a, namely in each corner of the effective screen 3c as shown in FIG. 1, are dedicated as the positional reflective screens 7. Given that the positional patterns 6 are projected onto these sections functioning as the positional reflective screens 7 in band R and that the interactive training scenario is projected onto the inactive screen 3a in band V, the positional patterns 6 will not hinder the trainee's view of the interactive training scenario and the interactive training scenario as projected onto the inactive screen 3a will not hinder or distort the image of the positional patterns 6 as captured by the positional camera(s) 8.

The positional patterns 6, each comprising the localization sub-pattern 6a and the identification sub-pattern 6b, are shown in FIG. 1 and FIG. 2, whereas FIG. 1 shows the distribution of the positional patterns 6 on the inactive screen 3a, and FIG. 2 shows each positional pattern 6 in more detail. As seen in FIG. 2, each localization sub-pattern 6a comprises three dots, schematically shown as black dots, and is the same in all four positional patterns 6. Each identification sub-pattern 6b comprises one dot, in FIG. 2 schematically shown as a white dot, and in combination with the localization sub-pattern 6a makes each positional pattern 6 unique, as the position of the identification sub-pattern 6b dot relative to the position of the localization sub-pattern 6a is different from one positional pattern 6 to another.

The training system 1 comprises four positional cameras 8, two of which are mounted on two weapon replicas 9a, and two are mounted on two trainees' helmets 9b, respectively. The weapon replicas 9a used in this embodiment are an automatic rifle replica 9a and an antitank handheld weapon 9a. The positional camera 8 as mounted on the weapon replica 9a is directed basically in the weapon firing direction, for example in the same direction as and close to the barrel of the automatic rifle 9a, which enables that the position and the orientation of the positional camera 8 can be attributed to the position and orientation of the weapon replica 9a. The positional cameras 8, which are mounted on trainee's helmets 9b, are similarly directed in the same direction as the trainee's gaze if looking straight ahead, so that the position and orientation of these positional cameras 8 can be attributed to the position and orientation of the trainees 2 and also of their gaze. Information on the trainee's gaze during the training is useful for example in after action review to evaluate the trainee's level of competence and performance.

The computer 13 in this embodiment is implemented as a central computer 13a and four positional camera computers, each embedded with and connected to the corresponding positional camera 8, and a connection means 13b implemented as a WiFi module 13b. The positional camera computers are connected to the central computer 13a via WiFi wireless connection enabled by the WiFi module 13b.

The automatic rifle replica 9a is equipped also with an additional input device 11, namely with the triggering device 11, which is connected to the central computer 13a via WiFi wireless connection, so that the moment of pulling the trigger, i.e. firing, can be detected and communicated to the scenario software module for achieving the interaction between the trainee's activities and the interactive training scenario. The antitank handheld weapon 9a is also equipped with its own additional input device 11, i.e. the triggering device 11 for the same purpose.

The positioning software module, running on each positional camera computer, calculates the position and the orientation of the corresponding positional camera 8 from the captured images of the positional patterns 6 and communicates the information on the position and the orientation to the scenario software module, running on the central computer 13a.

The relevant objects 9 in this embodiment are thus two weapon replicas 9a and two trainees or their helmets 9b. In FIG. 1 also two relevant virtual objects 10 are shown, namely a building and two enemy combatants shown in the scenario as projected on the effective screen 3c.

The training system 1 in this embodiment comprises also a calibration camera 14 which is fixedly attached relative to the pattern projecting device 5 in such close proximity and facing essentially the same direction so that the position and the orientation of the calibration camera 14 can be essentially attributed to the position and orientation of the pattern projecting device 5. In this embodiment also the projector 3a is fixedly attached relative to the calibration camera 14 and to the pattern projecting device 5 and is facing essentially the same direction.

The central computer 13a, the WiFi module 13b, the projector 3b, the pattern projecting device 5 and the calibration camera 14, together with a power unit 17 for powering the mentioned devices, are housed in a portable case 16 with a height adjustable stand 16a, which is shown in FIG. 4. Preferably, the portable case 16 is constructed robustly and made of materials that withstand rough transport conditions.

Two fiducial markers 15 for achieving a preset position during the calibration method are used in this embodiment and are implemented as ArUco markers 15, printed on self-adhesive removable plates. During the calibration, one fiducial marker 15 is fixed adhesively on the inactive screen 3a at the border next to the lower left corner of the effective screen 3c, and the other fiducial marker 15 on the border next to the lower right corner of the effective screen 3c, and both outside the effective screen 3c, as shown in FIG. 3. After the calibration step, which involves placing the calibration camera 14 into the preset position, is completed, the fiducial markers 15 can be removed from the inactive screen 3a. Given that the fiducial markers 15 in this embodiment are placed outside of the effective screen 3c, they can remain there also during the training, because they will not hinder the trainee's view of the scenario as projected to the effective screen 3c.

The portable system thus comprises the computer 13, the projector 3b, the pattern projecting device 5, the power unit 17, at least one positional camera 8 and the portable case 16. Optionally, the portable system comprises also the calibration camera 14, at least one fiducial marker 15, the portable inactive screen 3a, weapon replicas 9a, and/or additional triggering devices 11.

In the embodiment shown in FIGS. 1 through 4, the portable system comprises the central computer 13a, the WiFi module 13b, the projector 3b, the pattern projecting device 5, the calibration camera 14, the power unit 17, all housed in the portable case 16, and also four positional cameras 8, each of them with the positional camera computer, two weapon replicas 9a, each of them with the triggering device 11 and two fiducial markers 15 implemented on self-adhesive removable plates. The inactive screen 3a is already at the site and is not a part of the portable system.

The embodiment of the training system 1 as shown in FIGS. 1 through 4 is set up as follows.

The inactive screen 3a is present already at the site where the training system 1 is to be set up. The portable case 16 is placed at the approximate distance from the inactive screen 3a so that the calibration camera 14, the pattern projecting device 5 and the projector 3b are directed toward the inactive screen 3a. Given that the positional reflective screens 7 are implemented as dedicated parts of the surface of the inactive screen 3a, steps 1 and 2 of the above described set up method are thereby achieved, setting up the main screen 3 and setting up the positional reflective screens 7.

Step 3 of the set up method, namely placing the calibration camera 14 in the preset position relative to the effective screen 3c is achieved by applying the fiducial markers 15 implemented as ArUco markers 15 on self-adhesive removable plates. As shown in FIG. 3, the ArUco markers 15 are placed beside lower corners of the effective screen 3c and in the same plane as the inactive screen 3a/effective screen 3c. The calibration camera 14 captures the image of both ArUco markers 15 and with known methods the fiducial software module, which runs on the central computer 13a, calculates the exact position and angles of the calibration camera 14 relative to the inactive screen 3a/effective screen 3c. In this embodiment, the position and angles of the inactive screen 3a are manually adjusted and the exact position and angles of the calibration camera 14 relative to the inactive screen 3a, as calculated by the fiducial software module, are observed, until the position and angles of the calibration camera 14 relative to the inactive screen 3a matches the preset position. In this embodiment the preset position is such that the calibration camera 14 is placed at the distance of 3 meters from the effective screen 3c and that an optical axis of the calibration camera 14 is perpendicular to the surface of the inactive screen 3a/the effective screen 3c and the distances from the point where the optical axis pierces the surface of the inactive screen 3a to both ArUco markers 15 are the same, so that the calibration camera 14 is also placed symmetrically relative to both ArUco markers. Angle φ in FIG. 3 represents possible rotation of the inactive screen 3a/the effective screen 3c relative to the calibration camera 14 around horizontal axis, and angle 8 around vertical axis. In the preset position described for this embodiment both angles are zero. The calibration camera 14 is shown schematically in FIG. 3 for illustrative purposes. After the preset position is achieved the fiducial markers 15 may be removed.

First part of step 4, namely placing the pattern projecting device 5 in a predefined position relative to the effective screen 3c, is automatically achieved by preceding steps given that the pattern projecting device 5 is already fixedly attached relative to the calibration camera 14, and that the preset position of the calibration camera 14 relative to the effective screen 3c has been achieved in step 3. Therefore, to complete step 4, the pattern projecting device 5 is switched on so that all four positional patterns 6 are projected onto the dedicated parts of the inactive screen 3a, namely onto the positional reflective screens 7.

In step 5 an initial image, which consists of blank (white) image is projected by the projector 3b to the inactive screen 3a, thereby delimiting the borders of the effective screen 3c.

In step 6, the calibration camera 14 captures the image of the positional patterns 6 in band R and the initial image in band V.

In step 7, based on these two images, as captured by the calibration camera 14, known position of the calibration camera 14, i.e. the preset position, known position of the pattern projecting device 5, and known positions of the positional patterns 6 as projected onto the positional reflective screens 7, the calibration software module calibrates the training system 1, namely computationally aligns the internal positional coordinate system of the positioning software module with the internal scenario coordinate system, so that the positions and/or orientations in a predefined format for each of the relevant objects 9 as an output of the positioning software module is applicable as input data for the scenario software module.

Thus, the training system 1 is set up and ready to be used for training.

1. A training system (1) for displaying an interactive training scenario and determining the positions and orientations of at least one relevant object (9), characterized in that, said system comprises
a main screen (3) configured for displaying the interactive training scenario within a band of electromagnetic wavelengths of visual light-band V;
at least two positional reflective screens (7) onto which at least two positional patterns (6) are projected, respectively;
a pattern projecting device (5) configured for projecting the positional patterns (6) onto the positional reflective screens (7), within a band of the EM wavelengths between 780 nm to 2500 nm-band R;
at least one positional camera (8) configured for capturing images in the band R and attached to at least one relevant object (9); and
a computer (13) with processing and memory capabilities and connection means configured for connecting at least with the main screen (3) and the positional camera(s) (8), and configured for running a positioning software module, which determines in real time the position and/or orientation of the relevant objects (9), and for running a scenario software module, which operates the displaying of the interactive training scenario on the main screen (3) and integrates the training scenario with the position(s) and orientation(s) of the relevant object(s) (9).

2. The training system (1) according to claim 1, wherein the main screen (3) is implemented as an inactive screen (3a) and a projector (3b) connected to the computer (13).

3. The training system according to claim 1, wherein an area on the main screen (3) delimited by the borders of the interactive training scenario as displayed on the main screen (3) is an effective screen (3c), wherein said effective screen (3a) is flat.

4. The training system (1) according to claim 1, wherein the positional reflective screens (7) are integrated with the main screen (3).

5. The training system (1) according to claim 1, wherein the pattern projecting device (5) projects the positional patterns (6) onto the positional reflective screens (7) within a band of the EM wavelengths between 800 nm to 1600 nm.

6. The training system (1) according to claim 1, wherein each positional pattern (6) comprises a localization sub-pattern (6a) which enables the positioning software module to determine the position and orientation of the positional camera (8) relative to the positional pattern (6), and an identification sub-pattern (6b) which makes by itself or in combination with the localization sub-pattern (6a) each positional pattern (6) unique.

7. The training system (1) according to claim 1, wherein the training system (1) further comprises at least one additional input device (11), preferably a triggering device (11) on the relevant object (9) which is implemented as a weapon replica (9a).

8. The training system (1) according to claim 1, wherein the training system (1) further comprises a calibration camera (14) configured for capturing images in the band V and the band R, and connected to the computer (13), and a calibration software module running on the computer (13) configured for operating a calibration process.

9. A set up method of the training system (1) according to claim 8, characterized in that it comprises the following steps:
step 1: setting up the main screen (3);
step 2: setting up the positional reflective screens (7);
step 3: positioning the calibration camera (14) in a preset position;
step 4: positioning the pattern projecting device (5) and projecting the positional patterns (6) onto the positional reflective screens (7);
step 5: displaying an initial image on the main screen (3);
step 6: capturing the image of the positional patterns (6) in band R and the initial image in band V;
step 7: computationally calibrating the internal positional coordinate system with the internal scenario coordinate system.

10. The set up method of the training system (1) according to claim 9, wherein step 3 is achieved by applying at least one fiducial marker (15) and fiducial software module running on the computer (13) by the following steps:
a) placing at least one fiducial marker (15), preferably two fiducial markers (15) positioned in two corners of the effective screen (3c), in the same plane as the effective screen (3c);
b) capturing the image of the fiducial markers (15) by the calibration camera (8), and calculating by the fiducial software module the exact position of the calibration camera (14) relative to the fiducial markers (15);
c) moving the calibration camera (14) and/or the main screen (3) and observing the output of the fiducial software module until the exact preset position is achieved.

11. A portable system for setting up the training system (1) according to claim 2, wherein said portable system comprises the computer (13), the projector (3b), the pattern projecting device (5), the power unit (17), at least one positional camera (8) and a portable case (16).

12. The portable system according to claim 11, wherein said portable system additionally comprises the calibration camera (14) and at least one fiducial marker (15).

13. The portable system according to claim 11, wherein said portable system additionally comprises the portable inactive screen (3a) and at least one weapon replica (9a) with an additional triggering device (11).
